(19) United States
(12) Patent Application Publication
(10) Pub. No.: US 2010/0274758 A1
(43) Pub. Date: Oct. 28, 2010

(54) DATA PROCESSING METHOD, COMPUTER, AND DATA PROCESSING PROGRAM

(75) Inventors: Yasuhiro TAHARA, Hiratsuka (JP); Norihiro Hara, Kawasaki (JP); Wataru Kawai, Yokohama (JP); Shinsuke Hamada, Yokohama (JP)

Correspondence Address: FOLEY AND LARDNER LLP;SUITE 500, 3000 K STREET NW, WASHINGTON, DC, 20007, US

(73) Assignee: Hitachi, Ltd.

(21) Appl. No.: 12/702,794

(22) Filed: Feb. 9, 2010

(30) Foreign Application Priority Data
Apr. 27, 2009 (JP) 2009-107481

(51) Int. Cl. G06F 17/30

(52) U.S. Cl. 707/618; 707/625; 707/684; 707/E17.007

(57) ABSTRACT

Provided is a computer system including: an active system; and a standby system. The active system generates, when an update request is received, an after-update log, and sends the after-update log to the standby system at a predetermined timing. The standby system generates a before-update log based on the after-update log sent from the active system and the stored data, updates, after the before-update log is generated, the stored data based on the after-update log, and rolls, when a rollback request is received, the data back to the data before update based on the generated before-update log. Accordingly, it becomes possible to suppress an increase in period of time to reflect the data updated in the active system on the standby system, and to suppress an increase in period of time for rollback of the data performed in the standby system.

### CLAIM OF PRIORITY

The present application claims priority from Japanese patent application JP 2009-107481 filed on Apr. 27, 2009, the content of which is hereby incorporated by reference into this application.

### BACKGROUND OF THE INVENTION

This invention relates to a computer system including a plurality of computers, and more particularly, to a technology for improving availability of a computer system.

Development of information society requires that higher reliability be secured for systems because of a fear that a serious damage is caused by service shutdown due to a system fault or the like. Therefore, there are proposed a technology of constituting a redundant system by providing, in addition to a first computer (computer of an active system) that provides services, a second computer (computer of a standby system) that stands by so as to substitute for the first computer to execute a processing in a case where some fault has occurred in the first computer, to thereby improve reliability of the entire system, and a technology of periodically synchronizing data stored in the first computer with data stored in the second computer, to thereby improve availability. Examples of the above-mentioned technologies include hot standby and disaster recovery.

Further, in order to utilize the entire redundant system efficiently, the second computer not only stands by as a spare system but is also used for another purpose, which is a general application of the second computer.

In such a redundant system as described above, in order to shorten a period of time necessary until the second computer starts to substitute for the first computer in the case where a fault has occurred in the first computer, or in relation to a data processing to be performed in the second computer, there is a need to reflect update results obtained in the first computer on the second computer as quick as possible in a state in which consistency of a transaction is maintained.

As the technology of synchronizing data stored in the first computer with data stored in the second computer, JP 2004-133598 A discloses a technology of sending, in a case where a transaction includes a large number of update operations, an after-update log to be sent to the second computer in midstream of the transaction instead of after each transaction has been ended.

According to the technology disclosed in JP 2004-133598 A, it is possible to suppress an amount of sent data at the time when the transaction is committed, and to shorten an update time necessary for synchronization on data performed in the second computer.

JP 2000-259505 A discloses a technology of sending an after-update log of the first computer to the second computer regardless of the transaction, and updating data stored in the second computer regardless of the transaction.

According to the technology disclosed in JP 2000-259505 A, the second computer only has a function of reflecting the after-update log sent from the first computer on the second computer, and the first computer controls commit and rollback of the transaction.

### SUMMARY OF THE INVENTION

In the technology disclosed in JP 2004-133598 A, the second computer reflects the after-update log after restructuring the after-update log on a transaction basis, and hence in a case where an amount of updated data obtained in the transaction is large, it takes a long period of time after the transaction of the first computer has been ended until an update of the second computer is ended.

In the technology disclosed in JP 2000-259505 A, the first computer sends a before-update log for rollback, and hence it takes a long period of time to roll back the transaction in which the amount of updated data is large.

As described above, in the technology for improving availability, in the case where the amount of updated data obtained in the transaction is large, it takes a long period of time for synchronization on data in the second computer at the time when the transaction is committed or rolled back.

As a result, it takes a long period of time to update data of the second computer to data at a stage of processing that the first computer has completed in, for example, a case where a fault has occurred in the first computer and the second computer takes over the processing, or to roll the data of the second computer back to a state before execution of the transaction, with the result that availability cannot be maintained at high level.

It is an object of this invention to propose a technology of realizing, in a second computer, both suppression of an increase in period of time necessary to commit a transaction in which an amount of updated data is large, and suppression of an increase in period of time necessary to roll back data in a case where a transaction is canceled.

The representative aspects of this invention are as follows. That is, there is provided a data processing method used in a computer system having a plurality of computers, the plurality of computers including: a first computer that stores data and receives a processing request for the data; and a second computer that stores data corresponding to the data stored in the first computer, the first computer having: a first interface for coupling the first computer to the second computer; a first processor coupled to the first interface; and a first memory coupled to the first processor, the second computer having: a second interface for coupling the second computer to the first computer; a second processor coupled to the second interface; and a second memory coupled to the second processor, the data processing method including the steps of: synchronizing, by the first computer, the data stored in the first memory with the data stored in the second memory; generating, by the first computer, in a case where an update request for the data is received, an after-update log including data after update; sending, by the first computer, the generated after-update log to the second computer at a predetermined timing; generating, by the second computer, a before-update log including data before update based on the after-update log sent from the first computer and the data stored in the second memory; updating, by the second computer, after the before-update log is generated, the data stored in the second memory based on the after-update log sent from the first computer; sending, by the first computer, in a case where a rollback request for the updated data is received, the rollback request to the second computer; and rolling, by the second computer, the data stored in the second memory back to the data before update based on the before-update log.

According to the aspect of this invention, it is possible to shorten the period of time necessary to reflect results of data update that is committed in the first computer (computer of the active system) on the second computer (computer of the standby system) particularly in the case where the amount of updated data is large. Accordingly, in a case where a fault has occurred in the first computer, for example, the period of time necessary until the second computer starts to take over the processing may be shortened. Further, in a case where the data update is canceled, the period of time necessary for the second computer to roll back the data may be shortened. Accordingly, in a case where a fault has occurred in the first computer, for example, it is possible to shorten the period of time necessary to cancel the data update executed in the second computer and then to re-execute the processing.

### BRIEF DESCRIPTION OF THE DRAWINGS

The present invention can be appreciated by the description which follows in conjunction with the following figures, wherein:

FIG. 1 is a block diagram illustrating an example of a configuration of a database system according to an embodiment of this invention;

FIG. 2 is a diagram illustrating structures of pieces of information respectively stored in main memories of a first computer and a second computer according to the embodiment of this invention;

FIG. 3 is a table illustrating an example of an after-update log of the first computer that functions as an active system according to the embodiment of this invention;

FIG. 4 is an explanatory diagram illustrating an example of the after-update log of the second computer that functions as a standby system according to the embodiment of this invention;

FIGS. 5A and 5B are explanatory diagrams each illustrating an example of a before-update log of the second computer of the standby system according to the embodiment of this invention;

FIG. 6 is an explanatory diagram illustrating outline of processings of the first computer and the second computer in a case where an update transaction is executed according to the embodiment of this invention;

FIG. 7 is an explanatory diagram illustrating timings to execute respective processings of the first computer and the second computer in a case where an update transaction is executed according to the embodiment of this invention;

FIG. 8 is an explanatory diagram illustrating outline of processings of the first computer and the second computer in a case where the update transaction is committed according to the embodiment of this invention;

FIG. 9 is an explanatory diagram illustrating timings to execute respective processings of the first computer and the second computer in a case where the update transaction is committed according to the embodiment of this invention;

FIG. 10 is an explanatory diagram illustrating outline of processings of the first computer and the second computer in a case where the update transaction is canceled and the DB data is rolled back according to the embodiment of this invention;

FIG. 11 is an explanatory diagram illustrating timings to execute the respective processings of the first computer and the second computer in a case where the update transaction is canceled and the DB data is rolled back according to the embodiment of this invention;

FIG. 12 is a flow chart illustrating procedures from activation of the database system to termination thereof according to the embodiment of this invention;

FIG. 13 is a flow chart illustrating procedures of DB data update processing executed in the second computer of the standby system according to the embodiment of this invention;

FIG. 14 is a flow chart illustrating procedures of a synchronization point processing executed in the second computer of the standby system according to the embodiment of this invention;

FIG. 15A is a flow chart illustrating procedures of a processing executed in the second computer of the standby system at the time when the update transaction is committed according to the embodiment of this invention; and

FIG. 15B is a flow chart illustrating procedures of a processing executed in the second computer of the standby system at the time when the update transaction is rolled back according to the embodiment of this invention.

### DETAILED DESCRIPTION OF THE PREFERRED EMBODIMENT

Hereinbelow, referring to the accompanying drawings, description is given of an embodiment of a database system to which this invention is applied.

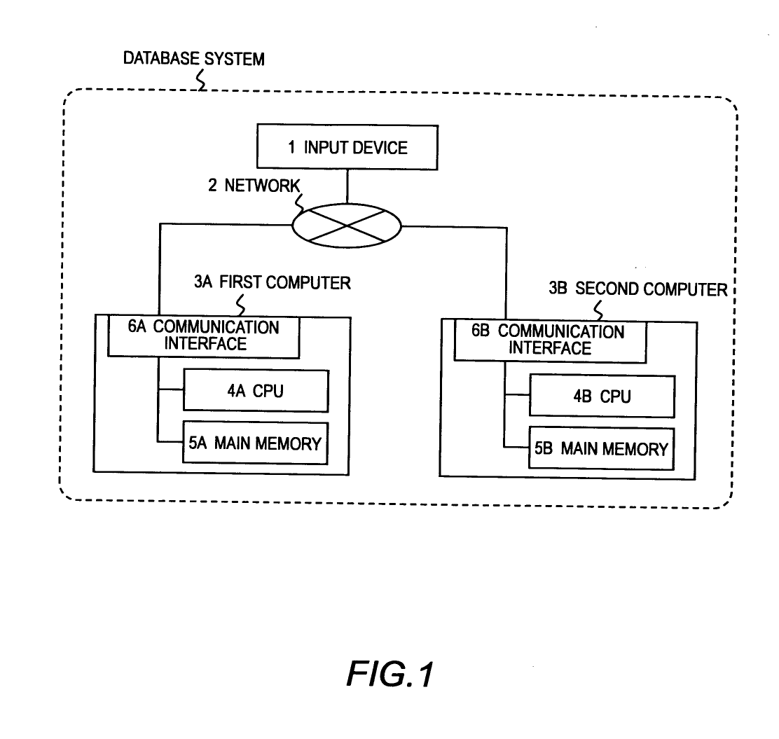

FIG. 1 is a block diagram illustrating an example of a configuration of the database system according to the embodiment of this invention.

The database system according to this invention includes an input device 1, a first computer 3A, and a second computer 3B. The input device 1, the first computer 3A, and the second computer 3B are coupled to one another via a network 2.

The input device 1 receives an input of a database operation request, and sends the database operation request to the first computer 3A. The first computer 3A is a computer of an active system, which executes a requested processing. The second computer 3B is a computer of a standby system, which substitutes for the first computer 3A to execute the processing in a case where a fault has occurred in the first computer 3A.

It should be noted that the database system may include a plurality of first computers 3A. For example, first computers 3A to be coupled are set for each input device 1, and in a case where a fault has occurred in any one of the first computers 3A, another one of the first computers 3A that is normally running may execute the requested processing instead of the second computer 3B.

The first computer 3A includes a central processing unit (CPU) 4A, a main memory 5A, and an interface 6A.

The CPU 4A executes programs stored in the main memory 5A to execute the requested processing.

The main memory 5A stores the programs executed by the CPU 4A and data processed based on the programs. Specifically, the main memory 5A stores a database management system. In the database system according to the embodiment of this invention, all pieces of data to be managed are stored in the main memory 5A.

The interface 6A is coupled to the network 2. Via the interface 6A, the first computer 3A receives the database operation request sent from the input device 1, and sends updated information of data to the second computer 3B.

The first computer 3A receives the database operation request sent from the input device 1, and executes a requested operation on the data stored in the main memory 5A. The first computer 3A may function also as a computer of a standby system.

As described above, the second computer 3B operates as the standby system for the first computer 3A. Specifically, the second computer 3B stands by while the first computer 3A operates as an active system, and when a fault has occurred in the first computer 3A, substitutes for the first computer 3A to execute the processing. After that, the second computer 3B may operate as an active system. Therefore, similarly to the configuration of the first computer 3A, the second computer 3B includes a CPU 4B, a main memory 5B, and an interface 6B. Functions of the components of the second computer 3B are the same as those of the first computer 3A.

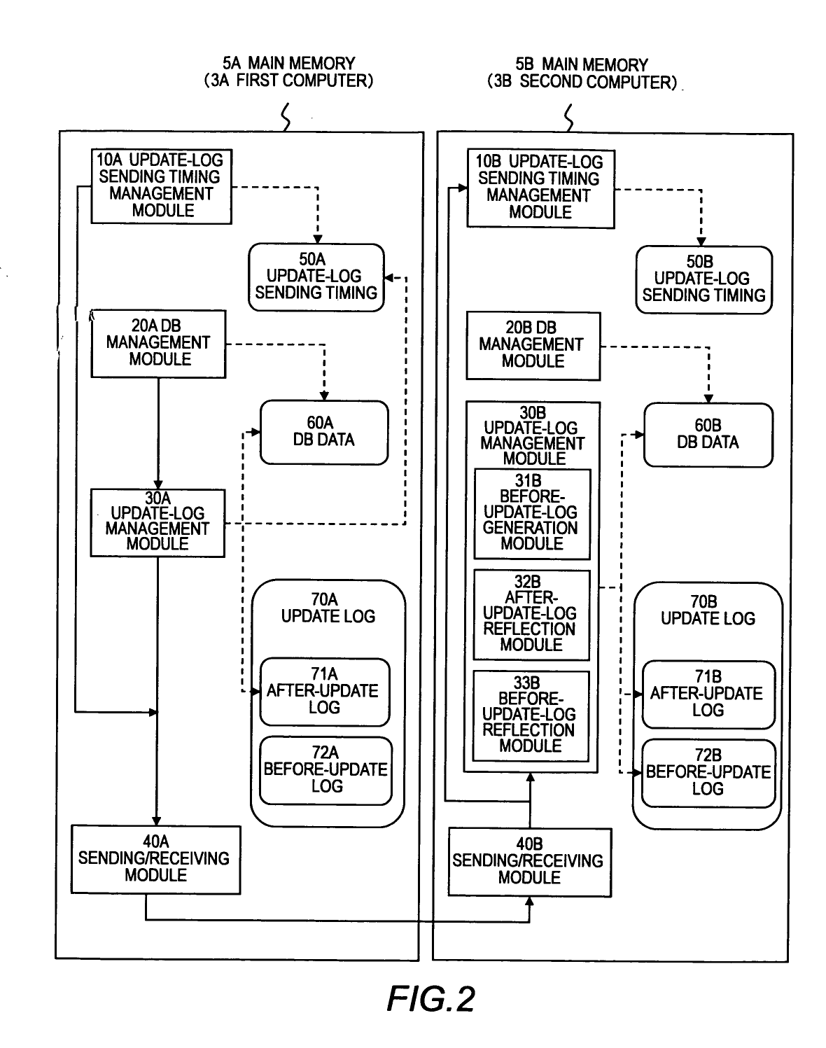

FIG. 2 is a diagram illustrating structures of pieces of information respectively stored in the main memories 5A and 5B of the first computer 3A and the second computer 3B according to the embodiment of this invention.

The main memory 5A of the first computer 3A stores an update-log sending timing management module 10A, a DB management module 20A, an update-log management module 30A, and a sending/receiving module 40A. The update-log sending timing management module 10A, the DB management module 20A, the update-log management module 30A, and the sending/receiving module 40A are programs executed by the CPU 4A.

The main memory 5A of the first computer 3A further stores an update-log sending timing 50A, DB data 60A, and an update log 70A.

The update-log sending timing management module 10A manages a timing to send an update log to the second computer 3B. The DB management module 20A receives the database operation request sent from the input device 1 via the sending/receiving module 40A, and executes the requested processing.

The update-log management module 30A creates an update log if the DB data 60A is updated when the DB management module 20A has executed the requested processing, and stores the created update log in the update log 70A.

The sending/receiving module 40A receives the database operation request sent from the input device 1. Further, the sending/receiving module 40A sends data after update and the like to the second computer 3B.

The update-log sending timing 50A is information indicating a timing to send an update log to the second computer 3B. The DB data 60A is data managed by the database system according to the embodiment of this invention. The update log 70A stores an update log with respect to the DB data 60A. The update log 70A includes an after-update log 71A and a before-update log 72A.

The main memory 5B of the second computer 3B stores an update-log sending timing management module 10B, a DB management module 20B, an update-log management module 30B, and a sending/receiving module 40B. The update-log sending timing management module 10B, the DB management module 20B, the update-log management module 30B, and the sending/receiving module 40B are programs executed by the CPU 4B.

Similarly to the main memory 5A of the first computer 3A, the main memory 5B of the second computer 3B further stores an update-log sending timing 50B, DB data 60B, and an update log 70B.

The update-log sending timing management module 10B receives, via the sending/receiving module 40B, a message indicating an update-log sending timing from the first computer 3A, and stores the update-log sending timing in the update-log sending timing 50B.

The DB management module 20B executes, in a case where the second computer 3B functions as an active system, a processing similar to the processing executed by the DB management module 20A.

The update-log management module 30B processes an update log sent from the first computer 3A. The update-log management module 30B includes a before-update-log generation module 31B, an after-update-log reflection module 32B, and a before-update-log reflection module 33B.

The before-update-log generation module 31B generates a before-update log based on the DB data 60B and the after-update log sent from the first computer 3A, and stores the before-update log in a before-update log 72B of the update log 70B.

The after-update-log reflection module 32B applies, to the DB data 60B, the after-update log sent from the first computer 3A to synchronize the DB data 60A and the DB data 60B with each other.

The before-update-log reflection module 33B applies, to the DB data 60B, the before-update log 72B to roll updated data back to a state before update.

The sending/receiving module 40B receives the after-update log sent from the first computer 3A, and transfers the after-update log to the update-log management module 30B.

The update-log sending timing 50B, the DB data 60B, and the update log 70B are the same as the update-log sending timing 50A, the DB data 60A, and the update log 70A, respectively, which are stored in the main memory 5A of the first computer 3A.

The update log 70B includes an after-update log 71B and the before-update log 72B. Description is given below of information stored in the after-update log 71B and the before-update log 72B. According to the embodiment of this invention, in a case where the first computer 3A has received a data update request, the first computer 3A does not update the DB data 60A until the first computer 3A receives a commit request for a transaction, and instead, stores updated contents in the after-update log 71A. Then, the first computer 3A sends the after-update log 71A to the second computer 3B at a predetermined timing.

When the second computer 3B has received the after-update log 71A, the second computer 3B uses the after-update-log reflection module 32B of the update-log management module 30B to reflect the received after-update log 71A on the after-update log 71B. Further, the second computer 3B uses the before-update-log generation module 31B to generate the before-update log 72B based on the after-update log 71A sent from the first computer 3A and the DB data 60B.

The description has been given of the configurations of the first computer 3A that functions as an active system and the second computer 3B that functions as a standby system. It should be noted that, as described above, the first computer 3A and the second computer 3B may function both as an active system and as a standby system.

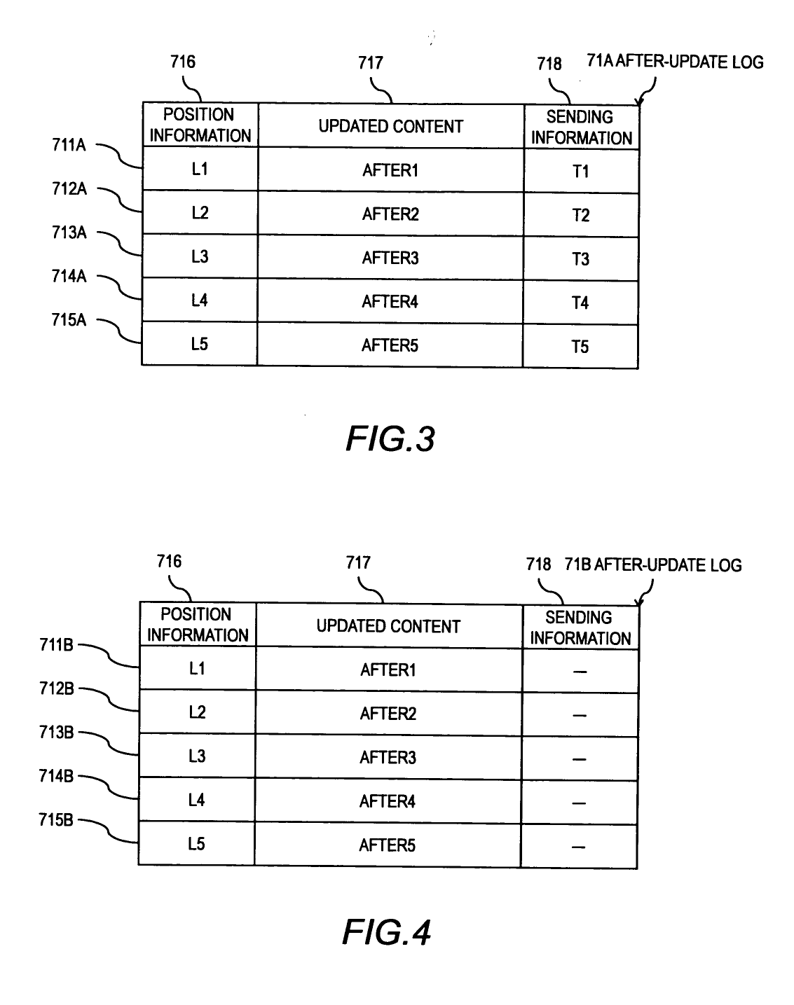

Hereinbelow, referring to FIGS. 3 to 15B, description is given of details of the structures of the pieces of information illustrated in FIG. 2.

FIG. 3 is a table illustrating an example of the after-update log 71A of the first computer 3A that functions as the active system according to the embodiment of this invention.

The after-update log 71A contains position information 716, an updated content 717, and sending information 718. In the example illustrated in FIG. 3, the after-update log 71A contains five records 711A, 712A, 713A, 714A, and 715A, but the number of records is not limited to five.

The position information 716 is a value uniquely indicating a physical or logical position of the DB data 60A at which data to be updated is stored. For example, the position information 716 corresponds to an address of a row in which data to be updated is stored, a serial number capable of uniquely identifying a row, a page number, or the like. L1, L2, L3, L4, and L5 are each a value indicating a position of the DB data 60A at which data to be updated is stored.

As the updated content 717, data contents after update and operation contents are recorded. AFTER1, AFTER2, AFTER3, AFTER4, and AFTER5 are values of pieces of data after update, respectively, which are stored at the positions L1, L2, L3, L4, and L5 of the DB data 60A.

The sending information 718 is information for managing a status of sending to the second computer 3B. T1, T2, T3, T4, and T5 are values respectively indicating whether the records 711A, 712A, 713A, 714A, and 715A have been sent or have not been sent yet to the second computer 3B. For example, “0” or “1” is set as values of T1 to T5. The value “0” indicates a state “unsent”, and the value “1” indicates a state “sent”. In addition, a value indicating another state such as a state “ready to send” may be set as the values of T1 to T5.

FIG. 4 is a table illustrating an example of the after-update log 71B of the second computer 3B that functions as the standby system according to the embodiment of this invention.

Similarly to the after-update log 71A illustrated in FIG. 3, the after-update log 71B contains position information 716, an updated content 717, and sending information 718. In the example illustrated in FIG. 4, the after-update log 71B contains five records 711B, 712B, 713B, 714B, and 715B.

It should be noted that, in a case where the system is not implemented so that the second computer 3B of the standby system transfers an after-update log to another computer, no value may be set as the sending information 718.

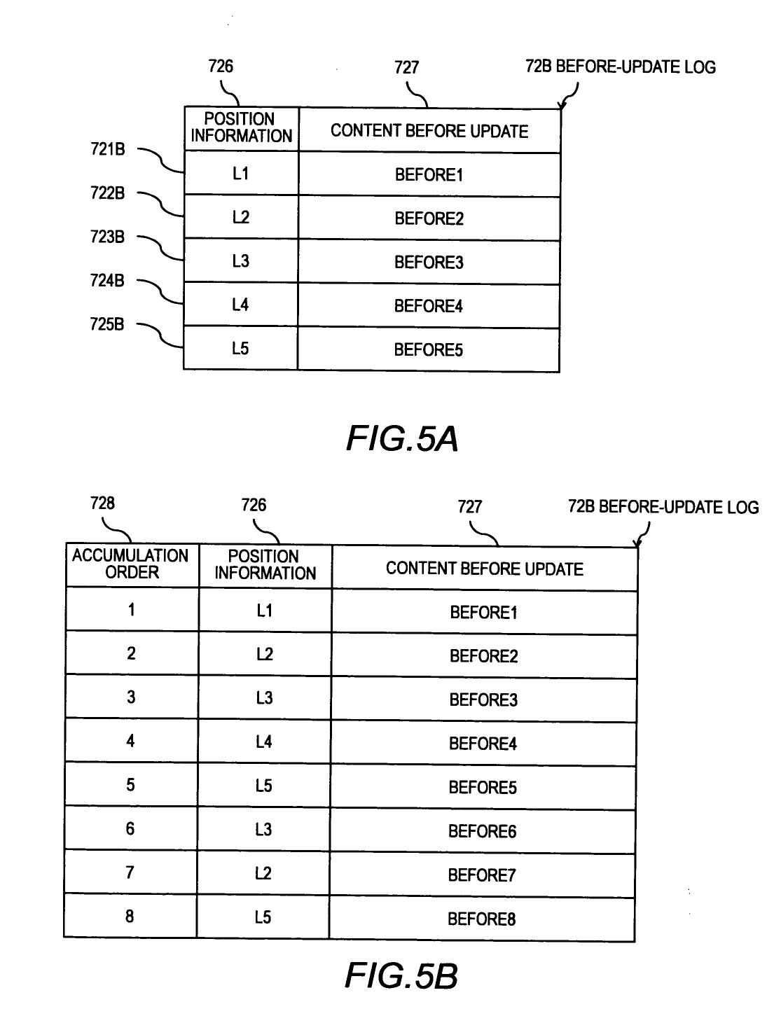

FIGS. 5A and 5B are tables each illustrating an example of the before-update log 72B of the second computer 3B of the standby system according to the embodiment of this invention.

As described above, the before-update log 72B is generated by the before-update-log generation module 31B of the second computer 3B of the standby system based on the after-update log sent from the first computer 3A of the active system to the second computer 3B of the standby system and the DB data 60B. With the use of the before-update log 72B, data is rolled back to data before update in a case where a transaction is canceled.

In FIG. 5A, in a case where pieces of data having the same position information are obtained through update conducted twice or more, the oldest information alone is recorded. The before-update log 72B illustrated in FIG. 5A contains position information 726 and a content before update 727.

As the position information 726, position information of updated data is recorded, and the position information 726 is the same as the position information 716 of FIG. 3. As the content before update 727, contents before update and operation contents of data corresponding to the position information 726 are recorded. The before-update log 72B illustrated in FIG. 5A contains five records 721B, 722B, 723B, 724B, and 725B, but the number of records is not limited to five. BEFORE1, BEFORE2, BEFORE3, BEFORE4, and BEFORE5 are values of pieces of data before update, respectively, which correspond to positions L1, L2, L3, L4, and L5 of the DB data 60B.

In general, even when the same record has been updated a plurality of times before the transaction is committed, in order to cancel the update conducted through the transaction and to roll the data back to data before the update, the data is rolled back to data immediately before the start of the transaction. Hence, data before update obtained when the data is updated for the first time only needs to be held. Specifically, the second computer 3B uses the before-update-log generation module 31B to judge whether or not the before-update log 72B has, at the time of data update, a record having position information that matches with position information of data to be updated, and adds the record to the before-update log 72B only when the before-update log 72B has no such record.

FIG. 5B illustrates another example of the before-update log 72B than that of FIG. 5A. The before-update log 72B illustrated in FIG. 5B contains an accumulation order 728 in addition to the structure of the before-update log 72B illustrated in FIG. 5A, and in a case where records stored at the same position are obtained through update conducted twice or more, the records are recorded in an order in which the records have appeared. In a case where data is rolled back to data before update, the oldest data may be applied thereto, or all the contents before update may be applied thereto in an order from the newest accumulation to the oldest one.

The accumulation order 728 contained in the before-update log 72B may be omitted as long as the order is identified.

The before-update log 72B illustrated in FIG. 5A may have a smaller capacity than the before-update log 72B illustrated in FIG. 5B. Further, in the before-update log 72B illustrated in FIG. 5A, the number of applied records of the before-update log may be minimized. On the other hand, the before-update log 72B illustrated in FIG. 5B has an advantage that there is no need to judge whether or not data has been updated before. In the embodiment of this invention, the before-update log 72B in the format illustrated in FIG. 5A is employed.

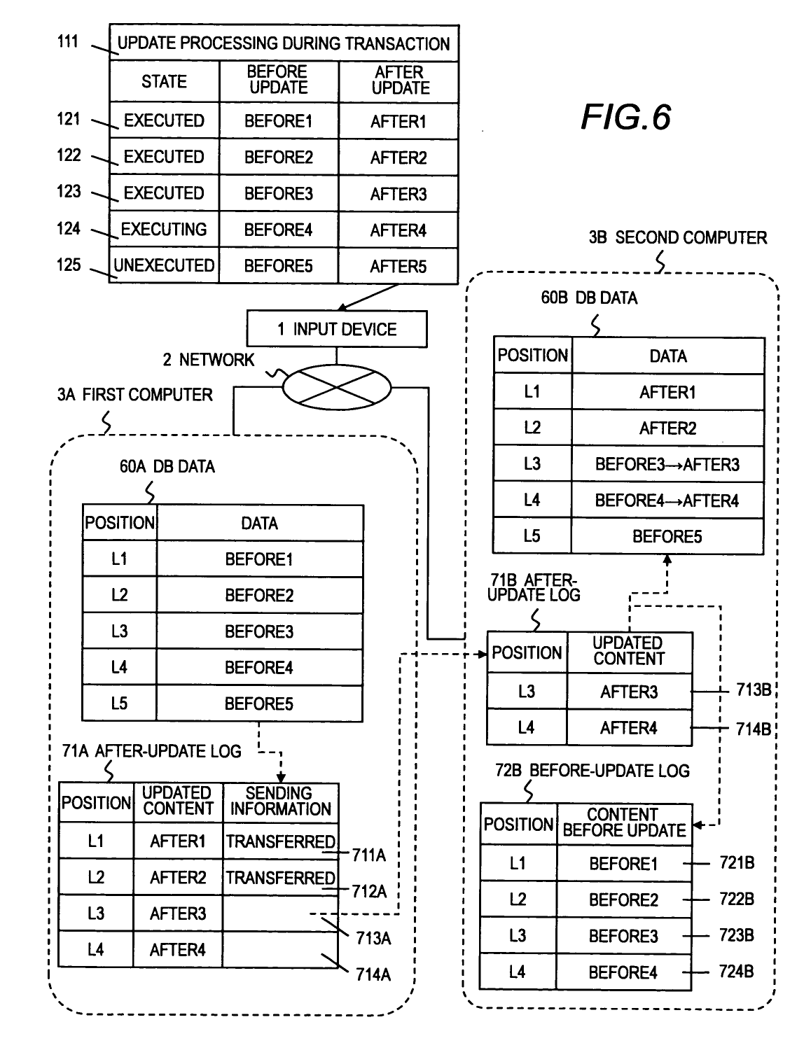

FIG. 6 is an explanatory diagram illustrating an outline of processings of the first computer 3A and the second computer 3B in a case where an update transaction is executed according to the embodiment of this invention.

A transaction 111 includes update operations 121, 122, 123, 124, and 125. The update operation includes a state, data before update, and data after update. As the item “state”, a value indicating that the update operation is in any one of states “executed”, “executing”, and “unexecuted” is set. The item “before update” represents a value of the DB data 60A before update, which is to be recorded in the update operation. The item “after update” represents a value of the DB data 60A after update, which is to be obtained in the update operation.

The transaction 111 indicates a state in which the update operations 121, 122, 123, and 124 have been input and thereamong, the update operation 124 is being executed.

With regard to the update operations 121 and 122, the corresponding records 711A and 712A of the after-update log have already been sent to the second computer 3B. The second computer 3B reflects the received values of pieces of data after update on the DB data 60B, generates a before-update log (records 721B and 722B) corresponding to the update operations 121 and 122, and stores the generated before-update log in the before-update log 72B.

In the first computer 3A, through the update operations 123 and 124, the records 713A and 714A of the after-update log are accumulated in the after-update log 71A. Then, the first computer 3A uses the update-log management module 30A to refer to the update-log sending timing 50A, and to detect a sending timing of the after-update log 71A. After detecting the sending timing, the first computer 3A uses the update-log management module 30A to refer to the values of sending information of the records of the after-update log 71A, to judge that the records 713A and 714A have not been sent yet, and to send a message of the judgment to the sending/receiving module 40A.

The first computer 3A sends, via the sending/receiving module 40A to the second computer 3B, the records 713A and 714A of the after-update log 71A that have not been sent yet. After that, the first computer 3A sets the values of the sending information of the records that have been sent to “transferred”.

The second computer 3B receives, via the sending/receiving module 40B, the records 713A and 714A of the after-update log 71A of the first computer 3A, and stores the received records as the records 713B and 714B of the after-update log 71B.

The second computer 3B uses the before-update-log generation module 31B of the update-log management module 30B to refer to pieces of position information of the records 713B and 714B of the after-update log 71B, and to acquire the values BEFORE3 and BEFORE4 before update from the positions L3 and L4 of the DB data 60B. Then, the second computer 3B uses the before-update-log generation module 31B to generate the records 723B and 724B of the before-update log 72B, and to accumulate the records 723B and 724B.

The after-update-log reflection module 32B of the update-log management module 30B of the second computer 3B reflects the updated contents of the records 713B and 714B of the after-update log 71B on the positions L3 and L4 of the DB data 60B. After that, the after-update-log reflection module 32B discards the records 713B and 714B of the after-update log 71B.

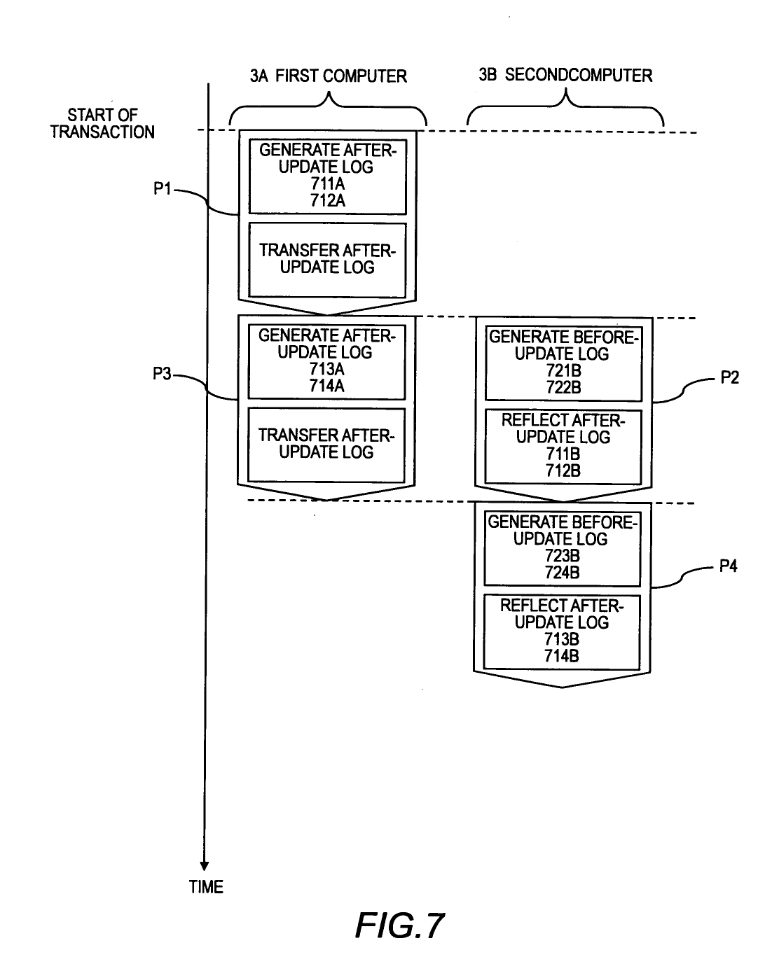

FIG. 7 is an explanatory diagram illustrating timings to execute the respective processings of the first computer 3A and the second computer 3B in the case where the update transaction is executed according to the embodiment of this invention.

The processings illustrated in FIG. 7 correspond to the processings described referring to FIG. 6. Processings P1 and P3 are processings executed by the first computer 3A, and processings P2 and P4 are processings executed by the second computer 3B.

In the processing P1, the first computer 3A generates the records 711A and 712A of the after-update log 71A, and sends the records 711A and 712A to the second computer 3B. After that, the first computer 3A executes the processing P3.

When the second computer 3B has received the records 711A and 712A of the after-update log 71A from the first computer 3A, in the processing P2, the second computer 3B stores the records 711A and 712A of the after-update log 71A as the records 711B and 712B of the after-update log 71B of the second computer 3B. Further, the second computer 3B generates the records 721B and 722B of the before-update log 72B, and thereafter, reflects the records 711B and 712B of the after-update log 71B on the DB data 60B. The processing P2 is executed in parallel to the processing P3 performed by the first computer 3A.

In the processing P3, the first computer 3A generates the records 713A and 714A of the after-update log 71A, and sends the records 713A and 714A to the second computer 3B. After that, the first computer 3A continues the processings.

When the second computer 3B has received the records 713A and 714A of the after-update log 71A from the first computer 3A, in the processing P4, the second computer 3B stores the records 713A and 714A of the after-update log 71A as the records 713B and 714B of the after-update log 71B. Further, the second computer 3B generates the records 723B and 724B of the before-update log 72B, and thereafter, reflects the records 713B and 714B of the after-update log 71B on the DB data 60B.

In the conventional method, data after update is not reflected on the second computer 3B of the standby system until the transaction is completed in the first computer 3A of the active system. In contrast, in the embodiment of this invention, the before-update log 72B is generated in the standby system, and hence data after update is reflected on the second computer 3B of the standby system at the predetermined timing (update-log sending timing) even during the processing of the transaction. With this configuration, it becomes possible to execute the processing P3 in the first computer 3A and the processing P2 in the second computer 3B in parallel to each other. Accordingly, it is possible to shorten the period of time necessary to reflect the results of the transaction on the computer of the standby system by a length of time that may be saved through the parallel execution of the processings. Thus, it is possible to shorten the period of time necessary until the first computer reflects the updated contents on the second computer and the second computer takes over the processing in, for example, the case where a fault has occurred in the first computer or the first computer is shut down as scheduled.

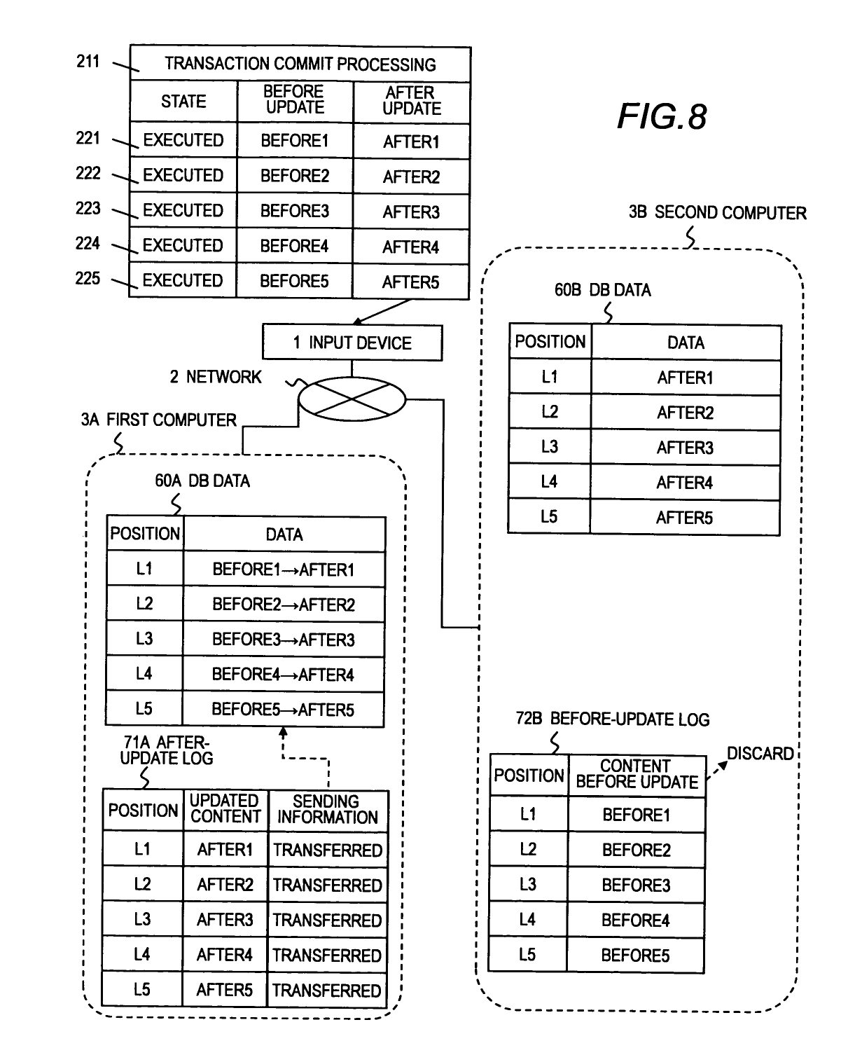

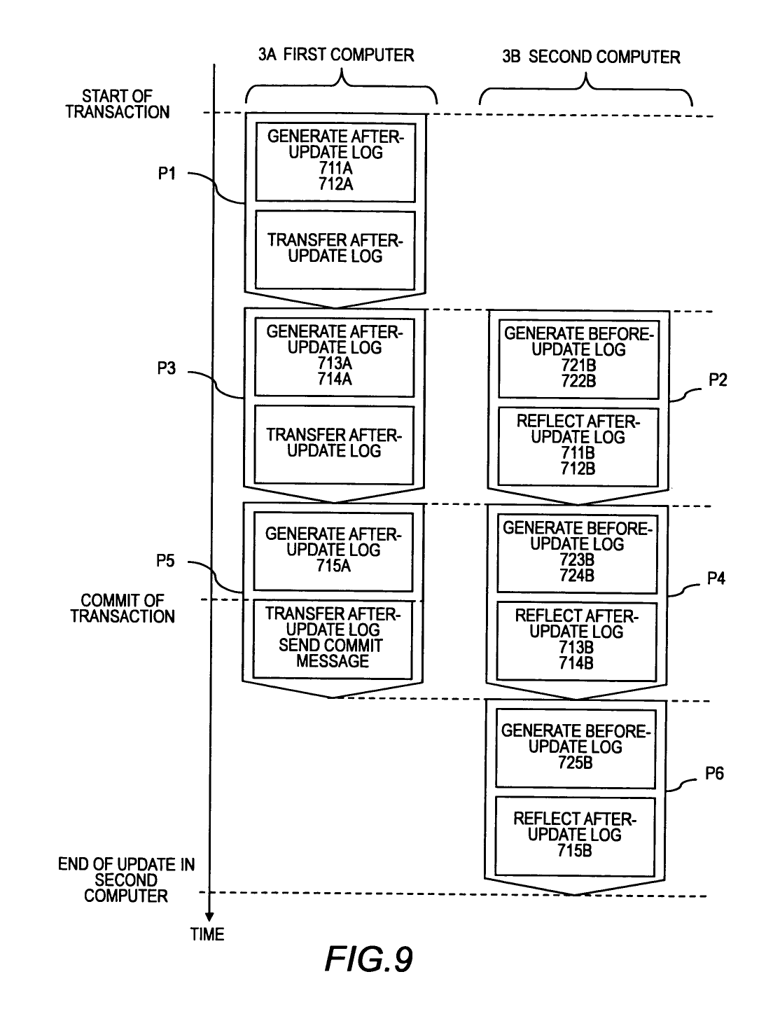

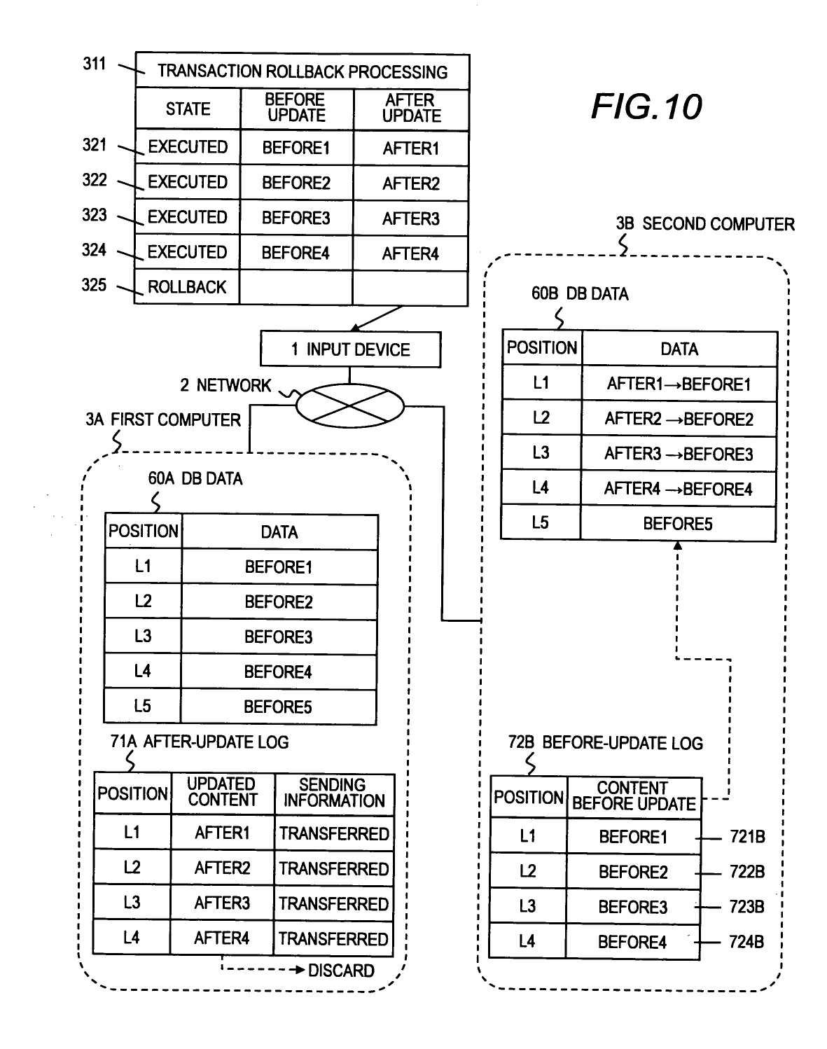

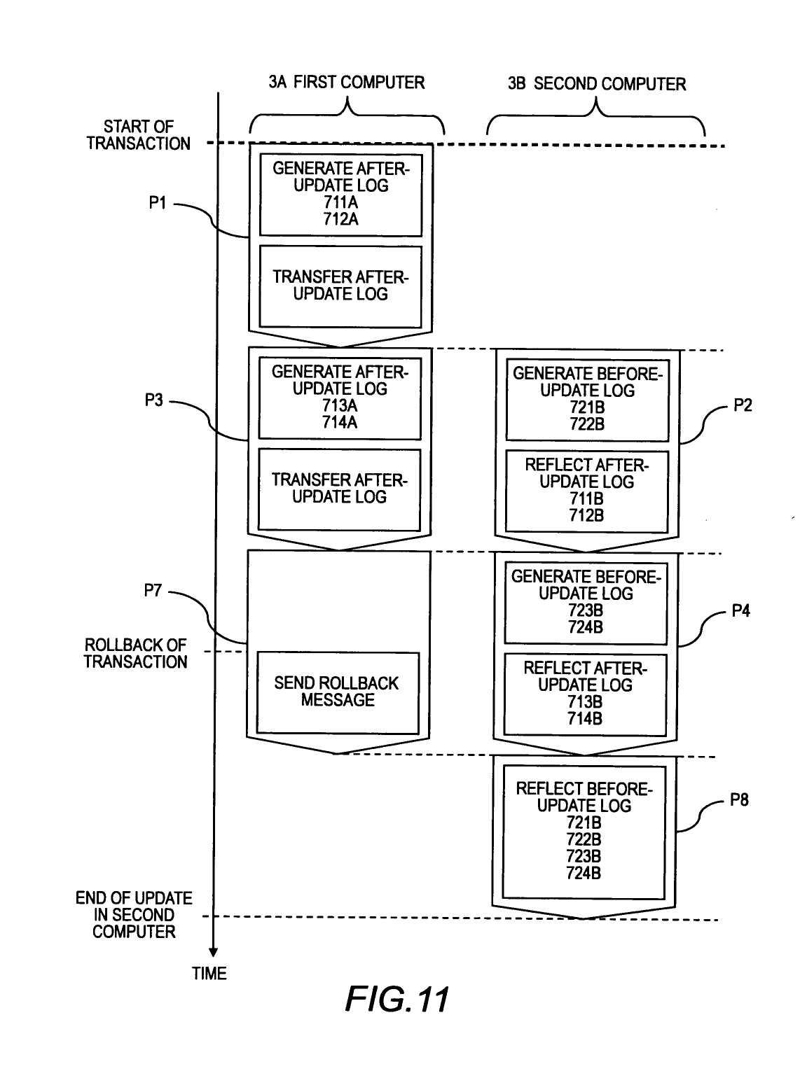

Hereinbelow, description is given of a case where the processings continue from the state illustrated in FIG. 6, all the update operations are normally finished, and the transaction is committed, and a case where the transaction is canceled and rolled back in a case where the processing has failed or in other such case. Referring to FIGS. 8 and 9, description is given of the case where the transaction is committed. Referring to FIGS. 10 and 11, description is given of the case where the transaction is canceled and rolled back.

FIG. 8 is an explanatory diagram illustrating an outline of processings of the first computer 3A and the second computer 3B in a case where the update transaction is committed according to the embodiment of this invention.

A transaction 211 includes update operations 221, 222, 223, 224, and 225. FIG. 8 illustrates a state after the processings illustrated in FIG. 6 have been executed. The update operations 221, 222, 223, 224, and 225 correspond to the update operations 121, 122, 123, 124, and 125 of FIG. 6, respectively. In the state illustrated in FIG. 8, all the update operations have been executed, the update results up to the update operation 225 have been reflected on the DB data 60B, and the transaction is about to be committed.

When the first computer 3A has received a commit request for the transaction in this state, the first computer 3A uses the update-log management module 30A to reflect the updated contents of all the records of the after-update log 71A on the DB data 60A of the first computer 3A. After that, the first computer 3A uses the sending/receiving module 40A to send a message indicating the commit request to the second computer 3B.

When the second computer 3B has received the commit message from the first computer 3A, the data update is committed and hence the before-update log 72B is unnecessary. Thus, the second computer 3B discards the before-update log 72B accumulated by the update-log management module 30B.

FIG. 9 is an explanatory diagram illustrating timings to execute the respective processings of the first computer 3A and the second computer 3B in the case where the update transaction is committed according to the embodiment of this invention.

FIG. 9 illustrates processings starting from the first processing (P1) of the update transaction, and processings P1 to P4 of FIG. 9 are common to those of FIG. 7.

In a processing P5, the first computer 3A generates the record 715A of the after-update log 71A, and thereafter, when the first computer 3A has received the message indicating the commit request for the transaction, the first computer 3A sends, via the sending/receiving module 40A to the second computer 3B, the record 715A of the after-update log 71A and the commit message of the transaction. It should be noted that, at this time, the processing P4 is executed in the second computer 3B in parallel to the processing P5 executed in the first computer 3A.

When the second computer 3B has received the record 715A of the after-update log 71A from the first computer 3A, in a processing P6, the second computer 3B stores the record 715A as the record 715B of the after-update log 71B. Further, the second computer 3B generates the record 725B of the before-update log 72B. After that, the second computer 3B reflects the record 715B of the after-update log 71B on the DB data 60B, and discards the record 715B of the after-update log 71B.

Further, the second computer 3B receives the commit message of the transaction, and discards the before-update log 72B because the data does not need to be rolled back to the state before the start of the transaction.

As described above, while the first computer 3A is processing the transaction, the second computer 3B starts the update processing. Hence, at the time when the transaction is committed, at least a part of the update processing for the DB data 60B of the second computer 3B has been completed. Accordingly, it is possible to shorten the period of time necessary to reflect the update results on the computer of the standby system at the time when the transaction is committed, even if the transaction includes a large number of update processings. Further, the amount of information generated and transferred by the first computer at the time when the transaction is committed is the same as that of the conventional technology, and hence the processing time necessary in the first computer at the time when the transaction is committed is the same as that of the conventional technology.

FIG. 10 is an explanatory diagram illustrating an outline of processings of the first computer 3A and the second computer 3B in a case where the update transaction is canceled and the DB data is rolled back according to the embodiment of this invention.

A transaction 311 includes update operations 321, 322, 323, and 324, and a rollback message 325. FIG. 10 illustrates a state after the processings illustrated in FIG. 6 have been executed. The update operations 321, 322, 323, and 324 correspond to the update operations 121, 122, 123, and 124 of FIG. 6, respectively. In the state illustrated in FIG. 10, processings up to the update operation 324 have been executed, the update results up to the update operation 324 have been reflected on the DB data 60B, and the transaction is about to be rolled back.

When the first computer 3A has received a rollback request for the transaction, the first computer 3A uses the update-log management module 30A to discard the after-update log 71A. In the first computer 3A, the update results are reflected on the DB data 60A after the first computer 3A has received the commit request for the transaction, and hence the first computer 3A only needs to discard the after-update log 71A in order to roll back the transaction. In this case, the first computer 3A may cancel the transaction in a state in which the before-update log 72A is not generated, and roll the DB data 60A back to the state before the update. After that, the first computer 3A uses the sending/receiving module 40A to send a rollback message to the second computer 3B.

When the second computer 3B has received the rollback message from the first computer 3A, the second computer 3B reflects the before-update log 72B accumulated by the before-update-log reflection module 33B on the DB data 60B of the second computer 3B, to thereby roll the DB data 60B of the second computer 3B back to the state before the start of the transaction.

FIG. 11 is an explanatory diagram illustrating timings to execute the respective processings of the first computer 3A and the second computer 3B in the case where the update transaction is canceled and the DB data is rolled back according to the embodiment of this invention.

FIG. 11 illustrates processings starting from the first processing (P1) of the update transaction, and processings P1 to P4 of FIG. 11 are common to those of FIG. 7.

In a processing P7, when the first computer 3A has received the rollback request for the transaction, the first computer 3A sends, via the sending/receiving module 40A, the rollback message of the transaction to the second computer 3B. On this occasion, the first computer 3A discards the after-update log 71A.

In a processing P8, when the second computer 3B has received the rollback message of the transaction from the first computer 3A, the second computer 3B reflects the accumulated before-update log 72B on the DB data 60B, to thereby roll the DB data 60B back to the state before the start of the transaction.

As described above, according to the embodiment of this invention, the second computer 3B generates the before-update log at the timing when the second computer 3B has received the after-update log 71A from the first computer 3A, and hence the second computer 3B does not need to newly acquire the before-update log from the first computer 3A at the time when the transaction is rolled back or on other such occasion. Accordingly, the second computer 3B may roll the DB data 60B back to the state before the start of the transaction by applying, to the DB data 60B, the before-update log that has been already generated, and hence the period of time necessary for the rollback may be shorten. Thus, it is possible to shorten the period of time necessary for the second computer to take over the processing after the data of the second computer is rolled back to the state before the execution of the transaction in the case where a fault has occurred in the first computer or the first computer is shut down as scheduled.

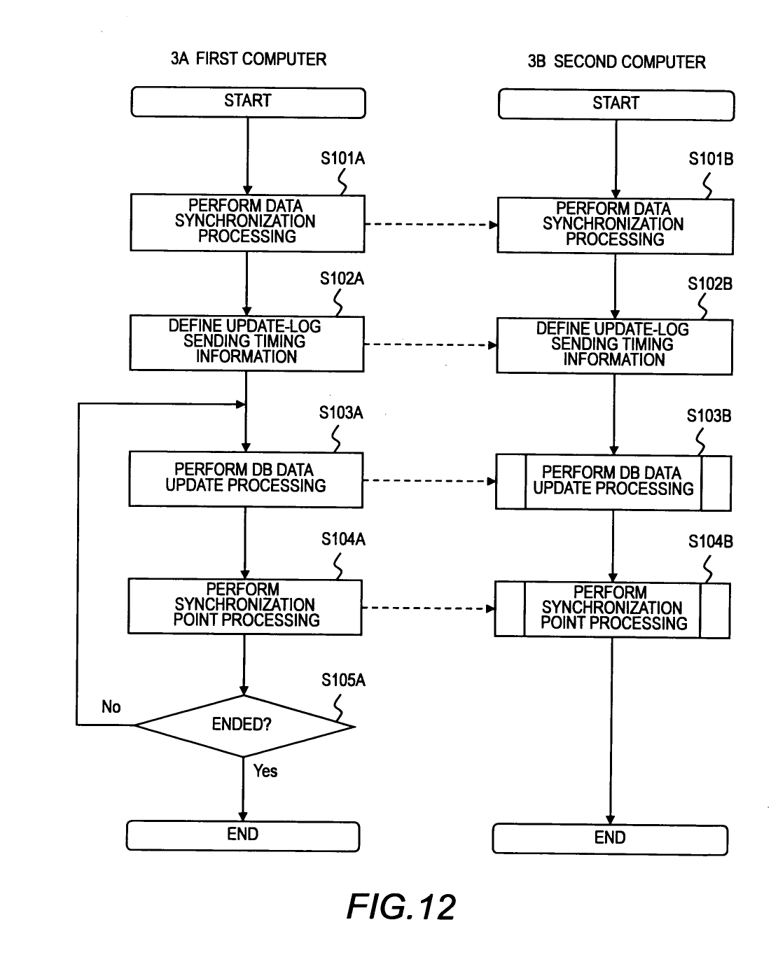

FIG. 12 is a flow chart illustrating procedures from activation of the database system to termination thereof according to the embodiment of this invention.

In order to start processings in the database system according to the embodiment of this invention, first, the computer of the active system (first computer 3A) and the computer of the standby system (second computer 3B) are activated.

In a case where the computer of the standby system (second computer 3B) is newly added to the database system, the CPU 4A of the first computer 3A sends the DB data 60A to the added computer, to thereby synchronize data between the first computer 3A and the second computer 3B. In a case where the DB data 60B is stored in the second computer 3B, the first computer 3A uses the update-log management module 30A to send the update log 70A to the computer of the standby system, to thereby synchronize the DB data between the first computer 3A and the second computer 3B by applying the update log 70A to the DB data 60B (S101A). It should be noted that a single second computer 3B of the standby system may be provided, or alternatively a plurality of second computers 3B of the standby system may be provided. In a case where the update log 70A is sent to each of the plurality of second computers 3B, it is efficient to send the update log 70A to the plurality of second computers 3B simultaneously through multicast communications or the like.

As a data synchronization processing, when the second computer 3B has received the after-update log 71A of the first computer 3A, the CPU 4B of the second computer 3B uses the update-log management module 30B to store the records of the received after-update log 71A in the after-update log 71B (S101B). In a case where the second computer 3B has received the DB data 60A, the received DB data 60A is stored as the DB data 60B.

The CPU 4A of the first computer 3A uses the update-log sending timing management module 10A to generate update-log sending timing information. The CPU 4A of the first computer 3A stores the generated update-log sending timing information in the update-log sending timing 50A, and at the same time, sends the update-log sending timing information to the update-log sending timing management module 10B of the second computer 3B (S102A).

The update-log sending timing information indicates a timing for the first computer 3A to send the after-update log 71A. For example, the update-log sending timing information indicates a case where the capacity of the after-update log 71A that has not been sent yet has reached a predetermined capacity, constant time intervals, a case where a specific operation has been executed, or the like. The update-log sending timing may be designated by a user via the input device 1, or may be determined by the database system automatically based on a system environment.

By sending the after-update log 71A from the first computer 3A in the case where the capacity of the after-update log 71A that has not been sent yet has reached the predetermined capacity, an excessive amount of load may be prevented from being imposed on the computer of the standby system. By sending the after-update log 71A from the first computer 3A at the constant time intervals, the DB data of the computer of the standby system may be updated periodically even in a case where it takes a long period of time from the start of the transaction to the end thereof and hence the update frequency is low. Alternatively, a plurality of timings may be set and the first computer 3A may send the after-update log 71A at any one of the timings. For example, the timing regarding the capacity of the after-update log and the constant time intervals are combined, to thereby deal with a case where the execution time of the transaction is relatively long and data is updated at a specific timing concentratively.

When the second computer 3B has received the update-log sending timing information, the CPU 4B of the second computer 3B uses the update-log sending timing management module 10B to store the received update-log sending timing information in the update-log sending timing 50B (S102B).

The CPU 4A of the first computer 3A uses the update-log management module 30A to generate an after-update log based on an update operation input from the input device 1, and to store the generated after-update log in the after-update log 71A (S103A). Further, the CPU 4A of the first computer 3A uses the update-log management module 30A to refer to the update-log sending timing 50A, and to send, to the second computer 3B, records that are stored in the after-update log 71A and have not been sent yet, at a sending timing of the after-update log 71A.

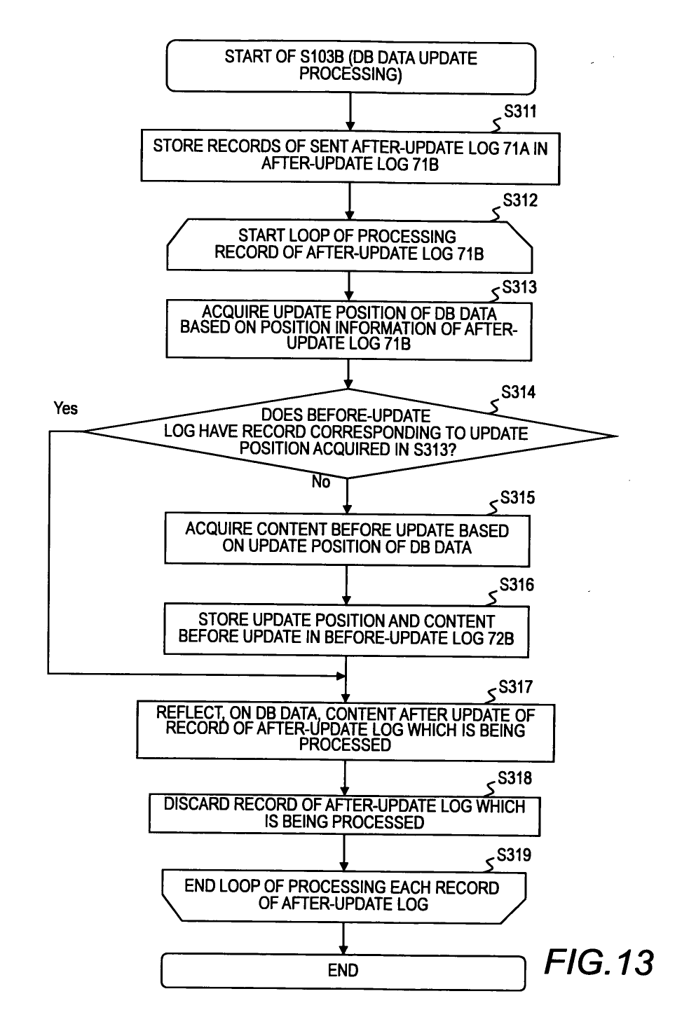

The CPU 4B of the second computer 3B uses the update-log management module 30B to store the received after-update log 71A in the after-update log 71B (S103B). After that, the CPU 4B of the second computer 3B uses the before-update-log generation module 31B to generate the before-update log 72B, and further, uses the after-update-log reflection module 32B to reflect the after-update log 71B on the DB data 60B. It should be noted that details of the DB data update processing (S103B) performed in the computer of the standby system (second computer 3B) are described later referring to FIG. 13.

The CPU 4A of the first computer 3A executes a synchronization point processing (S104A). There are two types of processing as the synchronization point processing, which are “commit” and “rollback”.

In a case where the synchronization point processing is “commit”, the CPU 4A of the first computer 3A uses the update-log management module 30A to send, via the sending/receiving module 40A to the second computer 3B, the records of the after-update log 71A that have not been sent yet. Further, the CPU 4A of the first computer 3A sends, to the second computer 3B, a message indicating that the synchronization point processing is “commit”.

When the CPU 4B of the second computer 3B has received the commit message of the transaction, in a case where the second computer 3B has the after-update log 71B, the CPU 4B of the second computer 3B uses the update-log management module 30B to execute a processing corresponding to the processing of S103B, to thereby apply an update log that has not been processed yet. Then, the CPU 4B of the second computer 3B discards the accumulated before-update log 72B (S104B).

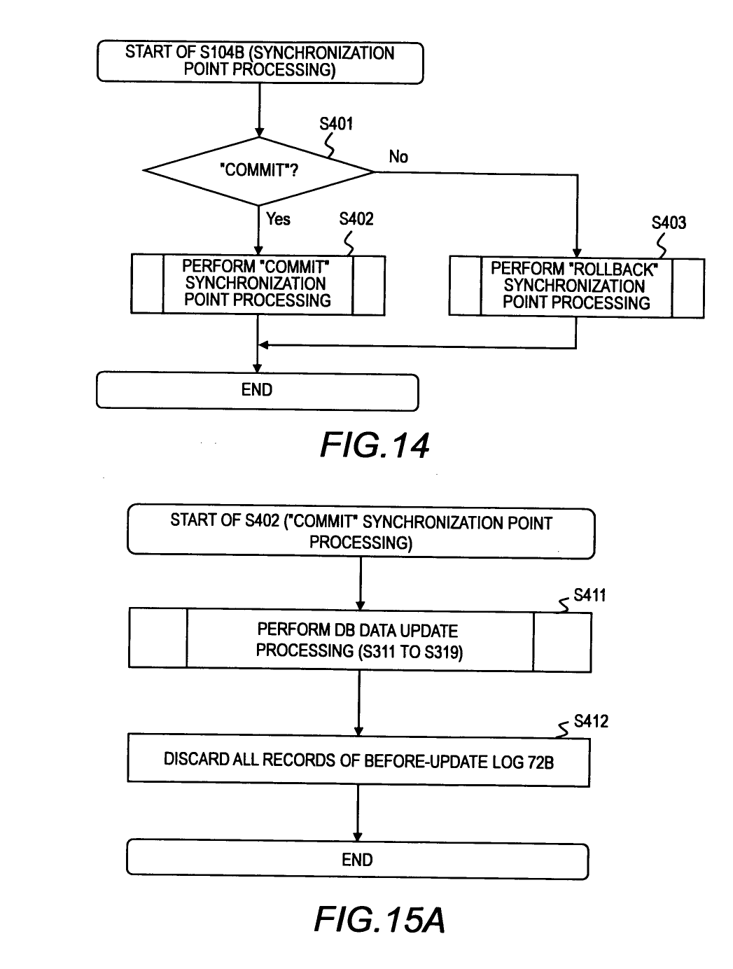

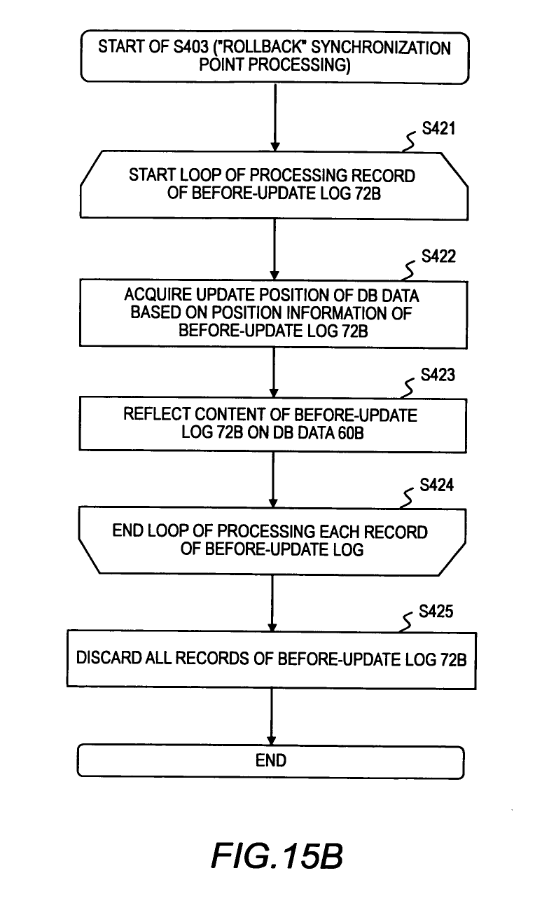

It should be noted that details of the synchronization point processing (S104B) performed by the computer of the standby system (second computer 3B) are described later referring to FIG. 14. Processings performed by the computer of the standby system in the case where the synchronization point processing is “commit” are described later referring to FIG. 15A.

In a case where the synchronization point processing is “rollback”, on the other hand, the CPU 4A of the first computer 3A uses the update-log management module 30A to discard the after-update log 71A (S104A). Further, the CPU 4A of the first computer 3A sends, via the sending/receiving module 40A to the second computer 3B, a message indicating that the synchronization point processing is “rollback”.

When the CPU 4B of the second computer 3B has received the rollback message of the transaction, the CPU 4B of the second computer 3B uses the before-update-log reflection module 33B of the update-log management module 30B to reflect the before-update log 72B on the DB data 60B, to thereby roll back the transaction (S104B). Processings performed by the computer of the standby system in the case where the synchronization point processing is “rollback” are described later referring to FIG. 15B.

When the synchronization point processing (S104A) has been ended, the CPU 4A of the first computer 3A judges whether or not to end the processings (S105A). In a case where the processings continue, such as a case where there remains data to be processed or a case where a new processing request is received (the result of S105A is “No”), the processing of S103A and the processings subsequent thereto are executed. On the other hand, in a case where all the requested processings have been completed and the system is terminated (the result of S105A is “Yes”), the processings are brought to an end.

FIG. 13 is a flow chart illustrating procedures of the DB data update processing (S103B) executed in the second computer 3B of the standby system according to the embodiment of this invention.

In this processing, the CPU 4B of the second computer 3B uses the update-log management module 30B to generate the before-update log 72B at the time when the update processing is executed, and to reflect the after-update log 71B on the DB data 60B.

First, the CPU 4B of the second computer 3B uses the update-log management module 30B to store records of the after-update log 71A sent from the first computer 3A in the after-update log 71B of the second computer 3B (S311).

The CPU 4B of the second computer 3B further uses the update-log management module 30B to execute the following processings from S313 to S318 for each of the records of the after-update log 71B (S312).

The CPU 4B of the second computer 3B further uses the update-log management module 30B to acquire position information of the acquired record from the after-update log 71B, to thereby identify a position of a record of the DB data 60B which is to be updated (S313).

The CPU 4B of the second computer 3B uses the before-update-log generation module 31B of the update-log management module 30B to search for the position of the before-update log 72B which corresponds to the identified position, to thereby judge whether or not the before-update log 72B has a record with the same position information as that of the record of the DB data 60B which is to be updated (S314). In a case where the before-update log 72B already has a record with the same position information (the result of S314 is “Yes”), the CPU 4B of the second computer 3B does not generate any before-update log, and executes the processing of S317 and processings subsequent thereto.

In a case where the before-update log 72B does not has a record with the same position information as that of the record of the DB data 60B which is to be updated (the result of S314 is “No”), the CPU 4B of the second computer 3B acquires, from the DB data 60B, a content of the record with the above-mentioned position information, and sets the content as a content before update (S315).

The CPU 4B of the second computer 3B uses the before-update-log generation module 31B of the update-log management module 30B to generate a record containing the update position information identified in the processing of S313 and the content before update acquired in the processing of S315, and to store the record in the before-update log 72B (S316).

The CPU 4B of the second computer 3B uses the after-update-log reflection module 32B of the update-log management module 30B to reflect a content of the after-update log 71B on the update position of the DB data 60B, which has been identified in the processing of S313 (S317). Further, the CPU 4B of the second computer 3B discards the record of the after-update log 71B which has been processed (S318). In this manner, in the computer of the standby system (second computer 3B), the updated data is reflected on the DB data 60B regardless of the synchronization method for the transaction.

The CPU 4B of the second computer 3B uses the update-log management module 30B to judge whether or not there is any record to be processed subsequently in the after-update log 71B. In a case where there is a record to be processed, the CPU 4B of the second computer 3B repeats the processings from S313 to S318, and in a case where there is no such record, ends the processings (S319).

Through the processings described above, the updated contents are reflected on the DB data 60B and the before-update log 72B is generated in the second computer 3B.

FIG. 14 is a flow chart illustrating procedures of the synchronization point processing (S104B) executed in the second computer 3B of the standby system according to the embodiment of this invention.

As described above, there are two types of processing as the synchronization point processing, which are “commit” and “rollback”. In the commit processing, an update processing included in a transaction is reflected on the DB data. On the other hand, in the rollback processing, the update processing included in the transaction is canceled, and the DB data is rolled back to a state before the start of the transaction.

The CPU 4B of the second computer 3B judges whether or not a message from the first computer 3A indicates that the synchronization point processing is “commit” (S401). In a case where the synchronization point processing is “commit” (the result of S401 is “Yes”), the CPU 4B of the second computer 3B executes a “commit” synchronization point processing corresponding thereto (S402). Details of the processing performed at the time when the update transaction is committed are described later referring to FIG. 15A. In a case where the synchronization point processing is “rollback” (the result of S401 is “No”), the CPU 4B of the second computer 3B executes a “rollback” synchronization point processing corresponding thereto (S403). Details of the processing performed at the time when the update transaction is rolled back are described later referring to FIG. 15B.

FIG. 15A is a flow chart illustrating procedures of the processing (S402) executed in the second computer 3B of the standby system at the time when the update transaction is committed according to the embodiment of this invention.

In a case where the second computer 3B has received, from the first computer 3A, a message indicating that the synchronization point processing is “commit” and an after-update log containing a record with which the DB data 60B has not been updated yet, first, the CPU 4B of the second computer 3B executes a DB data update processing (S411). The DB data update processing S411 is the same as the DB data update processing S103B including the processings from S311 to S319 of FIG. 13.

When the CPU 4B of the second computer 3B has reflected all records of the received after-update log on the DB data 60B, the CPU 4B of the second computer 3B uses the update-log management module 30B to discard all records of the before-update log 72B (S412). This is because data does not need to be rolled back to the state before the update due to the fact that the data update has been committed. After that, the processings are brought to an end.

FIG. 15B is a flow chart illustrating procedures of the processing (S403) executed in the second computer 3B of the standby system at the time when the update transaction is rolled back according to the embodiment of this invention.

The CPU 4B of the second computer 3B uses the update-log management module 30B to execute processings from S422 to S425 on each record contained in the before-update log 72B (S421).

The CPU 4B of the second computer 3B uses the before-update-log reflection module 33B of the update-log management module 30B to acquire a before-update position of the DB data 60B based on update position information of a record of the before-update log 72B which is to be processed (S422).

The CPU 4B of the second computer 3B uses the before-update-log reflection module 33B of the update-log management module 30B to acquire a content before update of the record of the before-update log 72B which is to be processed, and to reflect the content before update on the before-update position of the DB data 60B acquired in the processing of S422 (S423). In this manner, the CPU 4B of the second computer 3B acquires data before the start of the transaction from the before-update log 72B, to thereby roll the DB data 60B back to the state before the update.

The CPU 4B of the second computer 3B uses the before-update-log reflection module 33B of the update-log management module 30B to judge whether or not there is any record to be processed subsequently in the before-update log 72B (S424). In a case where there remains a record to be processed, the CPU 4B of the second computer 3B returns to the processing of S421.

When all the records of the before-update log 72B have been processed, the CPU 4B of the second computer 3B uses the before-update-log reflection module 33B of the update-log management module 30B to discard the before-update log 72B (S425).

According to the embodiment of this invention, the computer of the active system (first computer 3A) sends the update log to the computer of the standby system (second computer 3B) at the update-log sending timing regardless of whether or not the synchronization processing for the transaction has been executed. The second computer 3B stores the after-update log 71A sent from the first computer 3A as the after-update log 71B, and generates the before-update log 72B based on the after-update log 71B and the DB data 60B before update. Then, the second computer 3B reflects the after-update log 71B on the DB data 60B regardless of whether or not the synchronization processing for the transaction has been executed.

According to the embodiment of this invention, not all pieces of data need to be updated at the time when the transaction is committed, and hence it is possible to quickly synchronize data stored in the first computer 3A with data stored in the second computer 3B even in a case where the amount of data to be updated is large. Moreover, the update log is periodically sent to the second computer 3B at the update-log sending timing, and hence the second computer 3B may generate the before-update log 72B in parallel to the update processing performed by the first computer 3A. Accordingly, it becomes possible to further shorten the period of time necessary to commit the transaction in the first computer 3A and to reflect the update results on the second computer 3B.

Further, according to the embodiment of this invention, data may be rolled back to the state before update by reflecting, on the DB data 60B, the before-update log 72B generated in the second computer 3B. Therefore, the first computer 3A does not need to send the before-update log 72A to the second computer 3B, and only needs to send a message indicating the rollback of the transaction. Accordingly, at the time when the transaction is rolled back, it is possible to shorten the period of time necessary to send and receive the before-update log 72A, and particularly in a case where the amount of updated data is large, network traffic may be reduced.

As described above, according to the embodiment of this invention, it is possible to suppress the increase in period of time necessary to commit the transaction and to suppress the increase in period of time necessary for the rollback performed in the computer of the standby system (second computer 3B) at the time when the transaction is rolled back.

According to the embodiment of this invention, the first computer 3A does not generate the before-update log 72A. The before-update log 72A is not necessary because update operations are not reflected on the DB data 60A until the transaction is committed.

As a modification of the embodiment of this invention, the first computer 3A may reflect an update result on the DB data 60A every time the after-update log 71A is created. In this manner, at the time when the transaction is committed, the period of time to reflect the after-update log 71A on the DB data 60A is not necessary, and hence the period of time necessary to commit the transaction may further be shortened. In this case, the before-update log 72A is necessary at the time when the transaction is rolled back. At this time, the before-update log 72B generated by the second computer 3B may be acquired and stored as the before-update log 72A. On this occasion, by acquiring the before-update log 72B in an associative manner every time the update-log sending timing is reached, the first computer 3A does not need to acquire records of the before-update log 72B collectively at the time when the transaction is rolled back. Accordingly, it is possible to suppress the increase in period of time necessary to roll back the transaction.

Further, another modification of the embodiment of this invention is described below. In a case where the transaction is rarely canceled in a normal state, there is a fear that the computer of the active system is unstable for some reason. Therefore, the computer of the active system may be switched so that the computer of the standby system receives a processing request after the transaction has been rolled back.

While the present invention has been described in detail and pictorially in the accompanying drawings, the present invention is not limited to such detail but covers various obvious modifications and equivalent arrangements, which fall within the purview of the appended claims.

What is claimed is:

1. A data processing method used in a computer system having a plurality of computers,
the plurality of computers including:
a first computer that stores data and receives a processing request for the data; and
a second computer that stores data corresponding to the data stored in the first computer,
the first computer having:
a first interface for coupling the first computer to the second computer;
a first processor coupled to the first interface; and
a first memory coupled to the first processor,
the second computer having:
a second interface for coupling the second computer to the first computer;
a second processor coupled to the second interface; and
a second memory coupled to the second processor,
the data processing method including the steps of:
synchronizing, by the first computer, the data stored in the first memory with the data stored in the second memory;
generating, by the first computer, in a case where an update request for the data is received, an after-update log including data after update;
sending, by the first computer, the generated after-update log to the second computer at a predetermined timing;
generating, by the second computer, a before-update log including data before update based on the after-update log sent from the first computer and the data stored in the second memory;
updating, by the second computer, after the before-update log is generated, the data stored in the second memory based on the after-update log sent from the first computer;
sending, by the first computer, in a case where a rollback request for the updated data is received, the rollback request to the second computer; and
rolling, by the second computer, the data stored in the second memory back to the data before update based on the before-update log.

2. The data processing method according to claim 1, wherein:
the first computer further has a database running thereon, the database managing the data stored in the first memory;
the second computer further has a database running thereon, the database managing the data stored in the second memory;
the second computer is capable of receiving the processing request for the data in place of the first computer;
the update request for the data that is received by the first computer includes a transaction including at least one update operation; and
the data processing method further includes the steps of:
updating, by the first computer, in a case where a commit request for the transaction is received, the data stored in the first memory based on the generated after-update log;
sending, by the first computer, the commit request to the second computer;
deleting, by the second computer, the before-update log;
deleting, by the first computer, in a case where a rollback request for the transaction is received, the generated after-update log;
sending, by the first computer, the rollback request to the second computer; and
rolling, by the second computer, the data stored in the second memory back to the data before update based on the before-update log.

3. The data processing method according to claim 1, wherein the predetermined timing includes a timing at which a capacity of the generated after-update log exceeds a predetermined capacity.

4. The data processing method according to claim 1, wherein the predetermined timing includes a timing that is generated periodically at predetermined time intervals.

5. The data processing method according to claim 1, wherein:
the after-update log further includes position information indicating a position at which the data after update is stored; and
the data processing method further includes the steps of:
acquiring, by the second computer, in a case where the after-update log is received from the first computer, the position information of the data after update included in the after-update log;
acquiring, by the second computer, the data before update from the second memory based on the acquired position information; and
recording, by the second computer, as the before-update log, the data before update and the acquired position information in the second memory.

6. The data processing method according to claim 5, further including the steps of:
judging, by the second computer, whether or not the acquired position information of the data after update is included in the before-update log; and
generating, by the second computer, in a case where the acquired position information of the data after update is not included in the before-update log, a before-update log corresponding to the position information.

7. The data processing method according to claim 5, further including the steps of:
generating, by the second computer, the before-update log in an order in which the first computer receives the update request for the data; and
reflecting, by the second computer, in a case where the rollback request is received, the before-update log on the data stored in the second memory in an order opposite to the order in which the before-update log is generated, to thereby roll the data stored in the second memory back to the data before update.

8. The data processing method according to claim 1, further including the steps of:
acquiring, by the first computer, in a case where the rollback request is received, the before-update log generated by the second computer from the second computer; and
rolling, by the first computer, the data stored in the first memory back to the data before update based on the acquired before-update log.

9. The data processing method according to claim 1, wherein:
the plurality of computers further includes a plurality of the first computers; and
the data processing method further includes the steps of:
sending, by one of the plurality of the first computers, the generated after-update log to another one of the plurality of the first computers at the predetermined timing;
generating, by the another one of the plurality of the first computers, the before-update log including the data before update based on the after-update log sent from the one of the plurality of the first computers and the data stored in the first memory of the another one of the plurality of the first computers;
updating, by the another one of the plurality of the first computers, after the before-update log is generated, the data stored in the first memory of the another one of the plurality of the first computers based on the after-update log sent from the one of the plurality of the first computers; and
rolling, by the another one of the plurality of the first computers, in a case where the rollback request for the updated data is received from the one of the plurality of the first computers, the data stored in the first memory of the another one of the plurality of the first computers back to the data before update performed by the another one of the plurality of the first computers based on the before-update log.

10. The data processing method according to claim 1, further including the step of receiving, by the second computer, in a case where the first computer receives the rollback request, after the data stored in the second memory is rolled back to the data before update, the processing request for the managed data in place of the first computer.

11. A computer that stores data and synchronizes the data with data stored in another computer, comprising:
an interface for coupling the computer to the another computer;
a processor coupled to the interface; and
a memory that is coupled to the processor and stores the data,
wherein the processor is configured to:
synchronize the data stored in the memory with the data stored in the another computer;
generate, in a case where an update request for the data stored in the memory is received, an after-update log including data after update;
send the generated after-update log to the another computer at a predetermined timing;
generate, in a case where the after-update log is received, a before-update log including data before update based on the received after-update log and the data stored in the memory;
update, after the before-update log is generated, the data stored in the memory based on the received after-update log; and
roll, in a case where a rollback request for the updated data is received, the data stored in the memory back to the data before update based on the before-update log.

12. A storage medium recorded with a data processing program executed by a computer that synchronizes data stored in a memory with data stored in another computer,
the program controlling the computer to execute the steps of:
synchronizing the stored data with the data stored in the another computer;
generating, in a case where an update request for the stored data is received, an after-update log including data after update;
sending the generated after-update log to the another computer at a predetermined timing;
generating, in a case where the after-update log is received, a before-update log including data before update based on the received after-update log and the data stored in the memory;
updating, after the before-update log is generated, the data stored in the memory based on the received after-update log; and
rolling, in a case where a rollback request for the updated data is received, the data stored in the memory back to the data before update based on the before-update log.
